(19) United States
(12) Patent Application Publication
(10) Pub. No.: US 2009/0126690 A1
(43) Pub. Date: May 21, 2009

(54) Fuel pump

(76) Inventors: Paul Francis Garland, Gillingham (GB); Jonathan Gardner, Strood (GB)

Correspondence Address: DELPHI TECHNOLOGIES, INC., M/C 480-410-202, PO BOX 5052, TROY, MI, 48007, US

(21) Appl. No.: 12/287,897

(22) Filed: Oct. 14, 2008

(30) Foreign Application Priority Data
Oct. 16, 2007 (EP) 07254088.3

(51) Int. Cl. F02M 37/04

(52) U.S. Cl. 123/456; 123/495; 92/129

(57) ABSTRACT

Fuel pump for common rail engine comprises a plunger reciprocal within a bore to pressurize fuel within a chamber. A drive fir the plunger is co-operable with a cam rider so as to impart axial drive to the plunger while permitting lateral sliding movement of the cam rider. A plunger cycle includes a forward stroke, during which fuel within the chamber is pressurized, and a return stroke, during which the pump chamber fills with fuel at low pressure. The pump comprises a load-reducing arrangement for reducing the load on the drive due to fuel pressure within the chamber during that period of the forward stroke for which the relative velocity of sliding movement between the drive and the cam rider is at a minimum, thereby to reduce wear of the drive.

### FIELD OF THE INVENTION

The invention relates to a fuel pump of the type suitable for use in a common rail fuel injection system of an internal combustion engine. In particular, the invention relates to a fuel pump having at least one pumping plunger that is driven by means of a drive member co-operating with a cam rider mounted upon the engine cam shaft.

### BACKGROUND OF THE INVENTION

In a known common rail fuel pump, for example as described in EP 1 184 568A, three pumping plungers are arranged at equi-angularly spaced locations around an engine driven cam. Each plunger is mounted within a respective plunger bore provided in a pump housing and, as the cam is driven, each of the plungers is caused to reciprocate within its bore. As the plungers reciprocate, each causes pressurization of fuel within an associated pump chamber. The delivery of fuel from the pump chambers to a common high pressure supply passage is controlled by means of respective delivery valves associated with each of the pumps. The high pressure supply passage supplies fuel to a common rail, or other accumulator volume, for delivery to the downstream injectors of the injection system.

The cam carries a cam ring, also referred to as a cam rider, which travels over the surface of the cam as it is driven by the engine. It is known for each of the plungers to be coupled to a respective drive member in the form of a tappet, with each tappet located within a bore provided in a main pump housing and arranged so that, as the cam is driven, each tappet is caused to reciprocate within its respective bore, resulting in reciprocating motion to the plungers.

As the tappet is driven radially outward from the shaft, its respective plunger is driven to reduce the volume of the pump chamber. This part of the pumping cycle is referred to as the forward stroke of the plunger, during which fuel within the associated pump chamber is pressurized to a relatively high level. During a return stroke of the plunger, the plunger is urged in a radially inward direction under the influence of a plunger return spring.

As the rider rides over the cam surface to impart drive to the tappet along its axis, a base surface of the tappet is caused to translate laterally over a co-operating flattened surface of the rider. The tappet base also slides across the flattened rider surface in a similar manner during the return stroke. As the tappet slides over the surface of the cam rider, a frictional force is generated between the two surfaces. It is known to provide lubrication between the sliding surfaces of the tappet base and the cam rider by providing a relatively thin fluid film between the two surfaces to generate a transient fluid pressure. As the tappet is driven through the pumping cycle, the thin fluid film serves to reduce friction between the sliding surfaces, and as fluid it dispelled between the surfaces transient fluid pressure supports return loading of the tappet.

The thin film lubrication effect is well known, and mechanisms relying on this are known to exhibit reduced friction. The inventors have now realized, however, that thin film lubrication does not reduce friction between the tappet and the rider to a sufficient extent throughout the full pumping cycle, so that an unsatisfactory degree of wear of the tappet and/or the cam rider wear occurs during certain periods. This is a particular problem in today's common rail fuel pumps which are required to deliver fuel at very high pressure (e.g. in excess of 2000 bar) and so give rise to high pumping loads acting on the tappet.

It is an object of the invention to provide an improved fuel pump in which this problem is addressed.

### SUMMARY OF THE INVENTION

According to the present invention, there is provided a fuel pump for delivering fuel at rail pressure to a common rail of a fuel injection system, wherein the pump comprises a pumping plunger reciprocal within a plunger bore under the influence of a drive member (e.g. a tappet) so as to pressurize fuel within a pump chamber. The drive member is co-operable with a cam rider so as to impart axial drive to the plunger to reduce the volume of the pump chamber, in use, while permitting lateral sliding movement of the cam rider relative to the drive member. The pumping plunger performs a pumping cycle including a forward stroke during which the pumping plunger moves between bottom-dead-centre and top-dead-centre and fuel within the pump chamber is pressurized to a relatively high pressure level, and a return stroke during which the pumping plunger moves between top-dead-centre and bottom-dead-centre to allow the pump chamber to fill with fuel at a relatively low pressure level. The pump further comprises a load-reducing arrangement for reducing the load on the drive member due to fuel pressure within the pump chamber during that period of the forward stroke for which the relative velocity of sliding movement between the drive member and the cam rider is approximately a minimum.

During that period of the pumping cycle when the relative velocity between the drive member and the cam rider is at a minimum, thin film lubrication between the two surfaces has been found to be a minimum, and hence for this period of the cycle the drive member and the cam rider are most susceptible to wear due to the high pumping loads acting through the plunger. By providing a means for reducing the pumping load at this stage of the pumping cycle, the inventors have found that wear of the drive member can be reduced, thereby prolonging pump service life.

In a first embodiment, the load-reducing arrangement includes a spill port provided in the plunger bore. The spill port may be positioned so as to be covered by the plunger part way through the forward stroke (i.e. after an initial part of the forward stroke has lapsed) so as to delay the onset of pressurization until at least that point in the forward stroke at which the relative velocity of sliding movement between the drive member and the cam rider is approximately a minimum. With the spill port uncovered, movement of the plunger towards top-dead-centre causes fuel to be displaced from the pump chamber through the open port. Once the spill port is covered by the moving plunger, pressurization of fuel within the pump chamber commences.

According to this aspect of the invention, therefore, the fuel pump comprises a pumping plunger reciprocal within a plunger bore under the influence of a drive member so as to pressurize fuel within a pump chamber, the drive member being co-operable with a cam rider so as to impart axial drive to the plunger while permitting lateral sliding movement of the cam rider relative to the drive member, whereby the pumping plunger performs a pumping cycle including a forward stroke during which the pumping plunger moves between bottom-dead-centre and top-dead-centre and a return stroke during which the pumping plunger moves between top-dead-centre and bottom-dead-centre. The pump further comprises a spill port provided in the plunger bore at a position so as to be covered by the pumping plunger part way through the forward stroke and so as to delay the onset of fuel pressurization to rail pressure until approximately that point in the forward stroke at which the relative velocity of sliding movement between the drive member and the cam rider is approximately a minimum.

Typically, for example, the spill port is positioned in the plunger bore so as to be covered by the pumping plunger when the pumping plunger is at least 85 degrees after bottom-dead-centre. In one preferred embodiment, the spill port is positioned in the plunger bore so as to be covered by the pumping plunger when the pumping plunger is at least 90 degrees after bottom-dead-centre.

By carefully selecting the positioning of the spill port so that pumping only starts around or after the minimum point (i.e. when relative sliding velocity between the drive member and the cam rider is a minimum), the pumping load on the drive member is substantially non-existent for that period of the cycle when the drive member is most susceptible to wear.

In practice, the position of the spill port may be selected to provide a compromise between unloading the drive member at the critical angle around 90 degrees and maximizing the useful part of the stroke (i.e. pumping fuel) to increase pump capacity. For example, it may be helpful in some circumstances to delay closure of the spill port until some significant angle after 90 degrees (e.g. at least 110 degrees) to realize the full benefit of unloading the drive member in the critical period.

Alternatively, the spill port may be positioned so as to delay the onset of fuel pressurization until just before that point in the forward stroke at which the relative velocity of sliding movement between the drive member and the cam rider is a minimum. This would serve to increase pump capacity by utilizing a few degrees before the minimum point to effect pumping.

In another embodiment, the fuel pump may further include a valve arrangement operable to limit pressurization of fuel within the pump chamber to an intermediate pressure level, which is less than rail pressure, until at least that point in the forward stroke at which the relative velocity of sliding movement between the drive member and the cam rider is approximately a minimum.

As mentioned previously, pressurization may be limited to the intermediate level until just before the minimum point (e.g. about 85 degrees after bottom-dead-centre), until the minimum point (i.e. at 90 degrees after bottom-dead-centre) or just after the minimum point (i.e. at least 90 degrees after bottom-dead-centre).

The provision of the valve arrangement allows pressurization of fuel to take place for an initial period of the forward stroke, but when fuel pressure reaches the intermediate level the valve means is caused to open, holding pressure at the intermediate level until the point at which the spill port is again covered by the moving plunger continuing through the forward stroke. The pump chamber is primed to the intermediate pressure level at the minimum point (i.e. when relative sliding velocity between the drive member and the cam rider is a minimum), and as this pressure level is only relatively low the pumping load on the pumping plunger, and hence on the drive member, is relatively low when the drive member is most susceptible to wear.

In another embodiment, the pumping plunger is provided with a feature which aligns with the spill port to permit fuel to flow out of the pump chamber through the spill port during an intermediate portion of the forward stroke including the point at which the relative velocity of sliding movement between the drive member and the cam rider is approximately a minimum. This embodiment provides an increased pump capacity as pumping occurs during both an initial and latter portion of the forward stroke.

According to this aspect of the invention, there is provided a fuel pump for delivering fuel at rail pressure to a common rail of a fuel injection system, the fuel pump comprising a pumping plunger reciprocal within a plunger bore under the influence of a drive member so as to pressurize fuel within a pump chamber, the drive member being co-operable with a cam rider as to impart axial drive to the plunger while permitting lateral sliding movement of the cam rider relative to the drive member, whereby the pumping plunger performs a pumping cycle including a forward stroke during which the pumping plunger moves between bottom-dead-centre and top-dead-centre and a return stroke during which the pumping plunger moves between top-dead-centre and bottom-dead-centre. The pump further comprises a spill port provided in the plunger bore and wherein the pumping plunger is provided with a feature which aligns with the spill port to permit fuel to flow out of the pump chamber through the spill port during an intermediate portion of the forward stroke including a period for which the relative velocity of sliding movement between the drive member and the cam rider is a minimum.

In this embodiment, the intermediate portion of the pumping stroke may be between 70 and 110 degrees after bottom-dead-centre. If the intermediate portion starts at about 70 degrees, there is enough time (i.e. angle) for pressure in the pump chamber to reduce sufficiently during the spill phase of the initial pumping event before the critical angle of 90 degrees. As before, it may be helpful for closure of the spill port to occur at some significant angle after 90 degrees to realize the full benefit of unloading the drive member in the critical period.

In one particular embodiment, the fuel pump may further comprise one or more further pump chambers, the or each further pump chamber also having a further pumping plunger for performing a pumping cycle including a forward stroke during which the further pumping plunger moves between bottom-dead-centre and top-dead-centre and fuel within the further pump chamber is pressurized to a relatively high level, and a return stroke during which the further pumping plunger moves between top-dead-centre and bottom-dead-centre to allow the further pump chamber to fill with fuel at relatively low pressure. Each of the further pumping plungers has an associated drive member which is co-operable with the cam rider so as to impart axial drive to the further pumping plunger to reduce the volume of the further pump chamber, in use, while permitting lateral sliding movement of the cam rider relative to the associated drive member. Each further pumping plunger is provided with an associated load-reducing arrangement for reducing the load on its associated drive member due to fuel pressure within its pump chamber during that period of its forward stroke for which the relative velocity of sliding movement between its associated drive member and the cam rider is approximately a minimum.

In one preferred embodiment, each of the one or more further pump chambers is provided with a respective spill port to delay the onset of fuel pressurization by allowing fuel to flow out of the further pump chamber for an initial period of the forward stroke. Preferably, the or each spill port communicates with one of the other pump chambers of the pump to aid filling thereof during an associated return stroke.

It will be appreciated that preferred and/or optional features of the first embodiment of the invention may be combined with the second and third embodiments of the invention, and vice versa.

### BRIEF DESCRIPTION OF THE DRAWINGS

The invention will now be described, by way of example only, with reference to the following figures in which:

FIG. 1 is a cross section of a part of a known fuel pump including a pair of opposed plungers,

FIG. 2 is a graph to show pumping load and relative sliding velocity between the tappet and the cam rider in the known fuel pump in FIG. 1,

FIG. 3 is a cross section of a part of a fuel pump of a first embodiment of the invention,

FIG. 4 is a schematic diagram to illustrate the hydraulic circuit of the fuel pump in FIG. 3,

FIG. 5 is a graph, similar to FIG. 2, to show pumping load and relative sliding velocity between the tappet and the cam rider in embodiments of the present invention,

FIG. 6 is a schematic diagram, similar to FIG. 4, but corresponding to a second embodiment of the invention in which the fuel pump includes a pressure limiting valve associated with each plunger,

FIGS. 7(a) and 7(b) are cross sections of a part of the fuel pump of a third embodiment of the invention at (a) 90 degrees before top-dead-centre (TDC) and (b) at top-dead-centre (TDC), and

FIG. 8 is a schematic diagram, similar to FIGS. 4 and 6, but corresponding to the third embodiment of the invention in FIGS. 7(a) and 7(b).

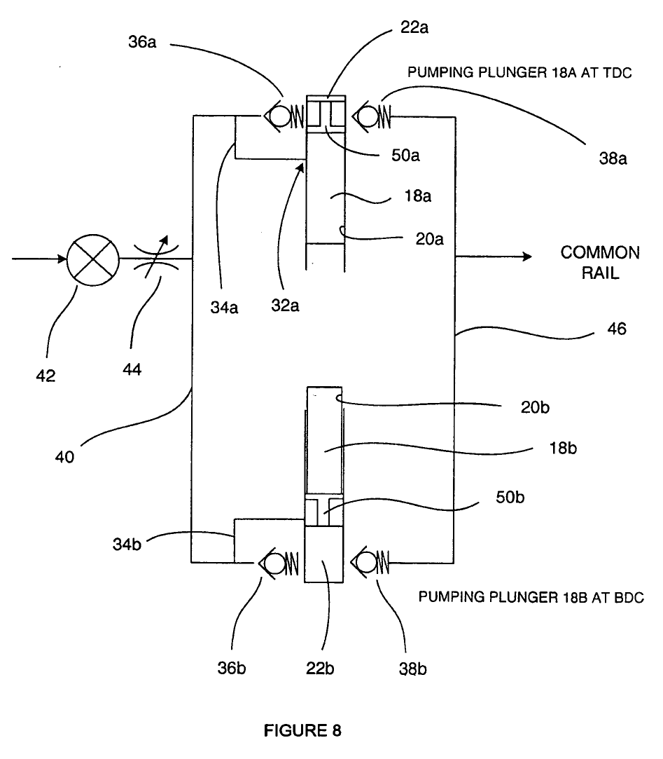

### DETAILED DESCRIPTION OF THE INVENTION

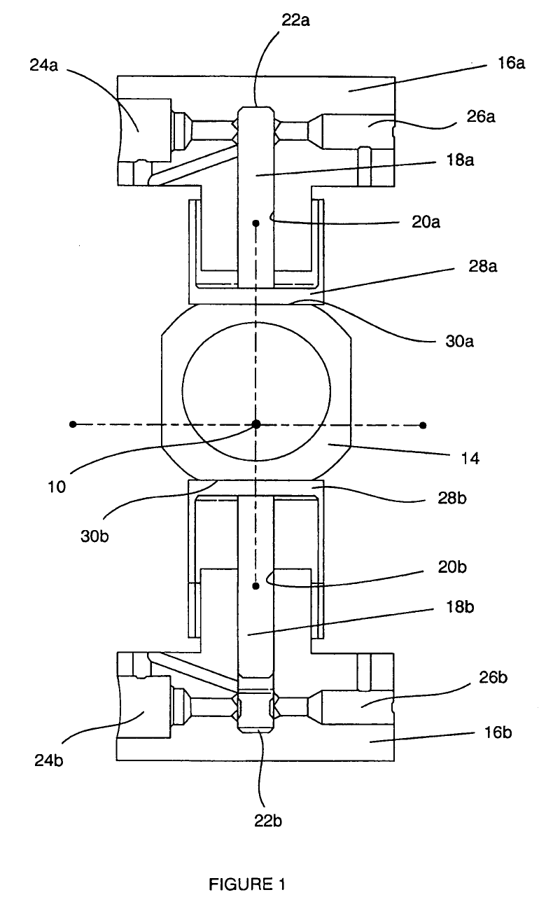

In order to better understand the advantageous features of the fuel pump of the present invention, there now follows a description of a known fuel pump, as shown, in part, in FIG. 1. The fuel pump is of the type having two opposed plungers which are driven in phased cyclical motion. The manner in which the plungers are driven is also applicable to known single-plunger or multi-plunger pumps having more than two plungers. The descriptions of operation which follow assume a full-filling condition (i.e. the pumping chamber is filled to maximum volume), unless otherwise stated.

The fuel pump includes a main pump housing (not shown) provided with an axially extending opening through which a cam drive shaft (centred at 10) extends when the assembly is installed within an associated engine. The drive shaft co-operates with a drive arrangement which includes an eccentrically mounted cam 12 carrying a cam ring or rider 14 having a generally circular-like internal cross section. Two pump heads, 16a, 16b, are mounted diametrically opposite one another around the cam 12. Each pump head 16a, 16b, includes a plunger, 18a and 18b respectively. Both pump heads 16a, 16b are identical to each other and so only one will be described in detail. In the accompanying figures, reference numbers applicable to the first pump head 16a include the suffix ‘a’ and reference numbers applicable to the second pump head 16b include the suffix ‘b’.

The plunger 18a of the first pump head 16a is reciprocal within a plunger bore 20a provided in the pump head 16a to cause pressurization of fuel within the pump chamber 22a defined at a blind end of the plunger bore 20a. The pump chamber 22a is provided with a spring-biased inlet valve (not shown) which opens to permit fuel to flow into the pump chamber 22a once the pressure differential across it exceeds a first predetermined level. The pump chamber 22a is also provided with an outlet valve (also not shown) which opens to permit pressurized fuel to flow out of the pump chamber 22a when the pressure differential across it exceeds a second predetermined level.

Fuel fills the pump chamber 22a through an inlet supply passage 24a, which is provided with the inlet valve, under the control of an inlet metering valve (not shown). Fuel within the pump chamber 22a is pressurized to a high level suitable for injection as the plunger 18a is driven to perform a pumping cycle including a forward stroke, between bottom-dead-centre (BDC) and top-dead-centre (TDC), and a return stroke, between top-dead-centre (TDC) and bottom-dead-centre (BDC). During the forward stroke, pressurized fuel is delivered from the pump chamber 22a to the downstream common rail through an outlet passage 26a which is provided with the outlet valve. During the return stroke the pump chamber 22a is filled with fuel at low pressure, ready for the next pumping cycle.

The plunger 18a has an associated drive member in the form of a tappet 28a. The tappet 28a is a bucket tappet, of generally U-shaped or channelled cross section, and includes a base and first and second side walls. The upper surface of the tappet base may be provided with a recess (not shown) for locating one end of a plunger return spring (not shown), mounted concentrically with the plunger, which serves to drive the plunger return stroke. A circlip or spring seat fitted to the plunger (not shown) couples the return spring to the plunger at its lower end. Although the tappet 28a and the plunger 18a are not physically coupled to one another, so that relative axial movement between the parts is permitted, the return spring tends to maintain tappet and plunger contact during movement.

A lower surface of the tappet base is co-operable with a flattened surface region (flat) 30a of the cam rider 14. The cam rider 14 is provided with two flats 30a, 30b, diametrically opposed around the rider so that each is co-operable with a base of a respective one of the two tappets 28a, 28b. The facing surfaces of each tappet 28a, 28b and the rider 14 define a very small clearance between them, which supports a thin film of lubricating fluid.

Considering operation of the first pump head 16a, as the rider 14 is caused to ride over the surface of the cam 12 upon rotation of the drive shaft, an axial drive force is imparted to the tappet 28a, and in turn to the plunger 18a, causing the plunger 18a to reciprocate within its bore 20a. Between BDC and TDC the tappet 28a and the plunger 18a are driven radially outward from the shaft to perform the forward stroke (i.e. vertically upwards in FIG. 1) to reduce the volume of the pump chamber 22a. Between TDC and BDC, the tappet 28a and the plunger 18a are urged in a radially inward direction to perform the return stroke (i.e. vertically downwards in FIG. 1) to increase the volume of the pump chamber 22a.

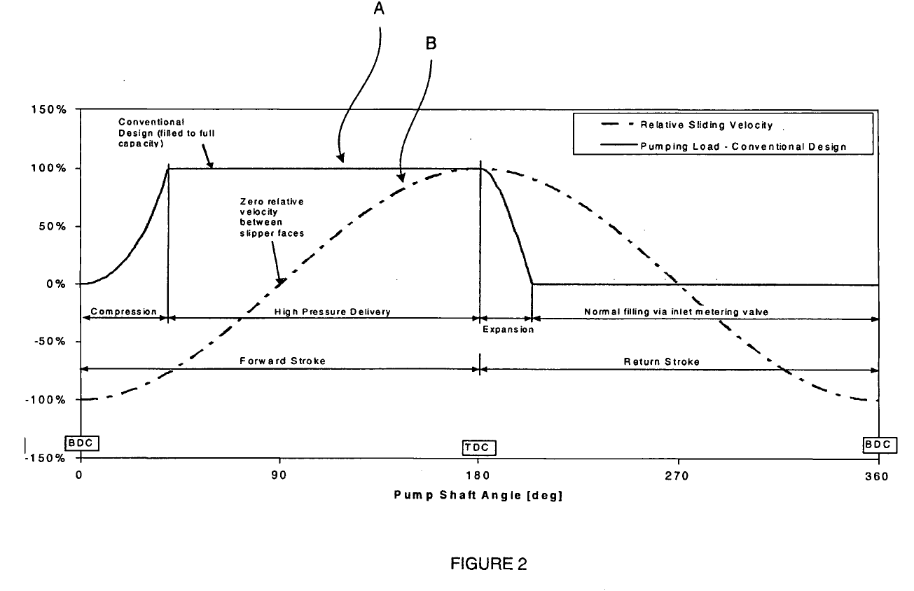

Referring to FIG. 2 it can be seen that as the plunger 18a is driven outwardly to reduce the volume of the pump chamber 22a (between BDC and about 40 degrees) compression occurs within the pump chamber 22a until the outlet valve is caused to open. The pump then enters a delivery phase (between about 40 degrees and 180 degrees) in which pressurized fuel is delivered through the outlet valve to the common rail. Once the plunger 18a has reached TDC and starts the subsequent return stroke, expansion occurs within the pump chamber 22a (between TDC and about 220 degrees) causing low pressure fuel to be drawn into the pump chamber 22a ready for the subsequent forward stroke.

Operation of the second pump head 16b is identical to that of the first pump head 16a, but 180 degrees out of phase with the first pump head 16a.

As the tappet 28a performs the forward stroke to impart drive to the plunger 18a in an axial direction, a degree of lateral or sliding movement of the tappet 28a occurs across the flattened rider surface 30a in a back and forth manner. The tappet 28a slides across the flattened rider surface 30a in a similar manner during the return stroke. As the surfaces 28a, 30a are displaced laterally relative to one another, the volume defined between them fills with, and dispels, lubricating fluid, in a cyclic manner. The thin fluid film between the sliding surfaces 28a, 30a serves to reduce friction between them, and as fluid it dispelled between the surfaces transient fluid pressure supports return loading of the tappet.

It has now been found, however, that thin film lubrication in a conventional pump does not reduce friction between the tappet and the rider to a sufficient extent throughout the full pumping cycle, so that an unsatisfactory level of tappet wear still occurs. It is a particular problem in current high pressure pumps where fuel is pressurized to very high levels, in excess of 1600 bar, and the pumping loads are very high.

By way of further explanation, it can be seen from line A in FIG. 2 that the pumping load is a maximum between about 40 degrees and 180 degrees of engine rotation. Line B in FIG. 2 indicates that the relative sliding velocity between the tappet 28a and the flattened rider surface 30a is a minimum at 90 degrees. The inventors have recognized that when the relative sliding velocity between the tappet 28a and the rider surface 30a is zero, thin film lubrication is substantially non-existent and so has little effect in reducing friction between the surfaces 28a, 30a. As the minimum in the relative sliding velocity coincides with a maximum in the pumping load, an undesirable degree of wear of the tappet 28a has been found to occur at 90 degrees which compromises pump reliability.

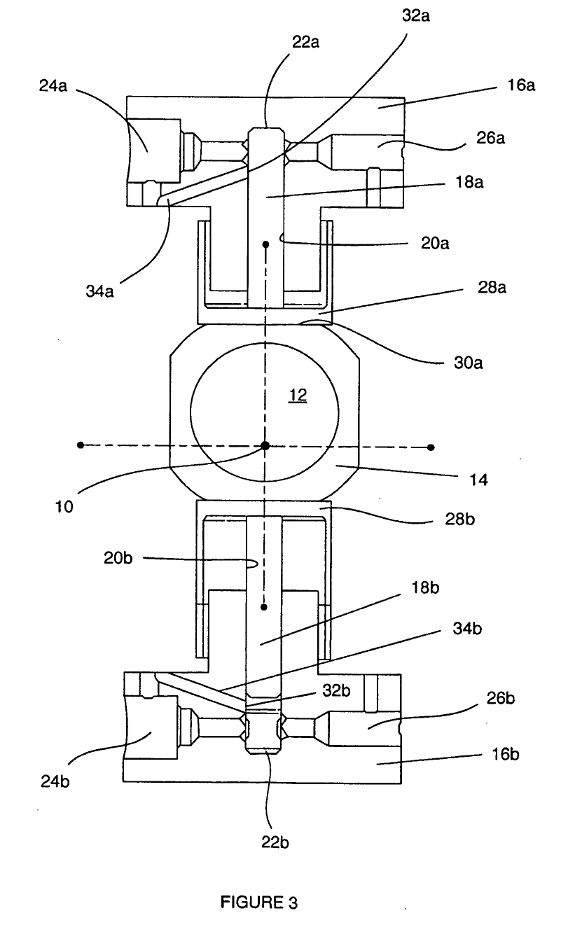

The fuel pump of the present invention overcomes this problem by providing a means for reducing the pumping load on the plunger 18a, and hence the tappet 28a, for that part of the cycle at which the thin film effect is minimal or non-existent (i.e. at and around 90 degrees). FIGS. 3 illustrates a first embodiment of the invention (design ‘a’), in which like parts to those shown and described with reference to FIG. 1 are identified by like reference numerals.

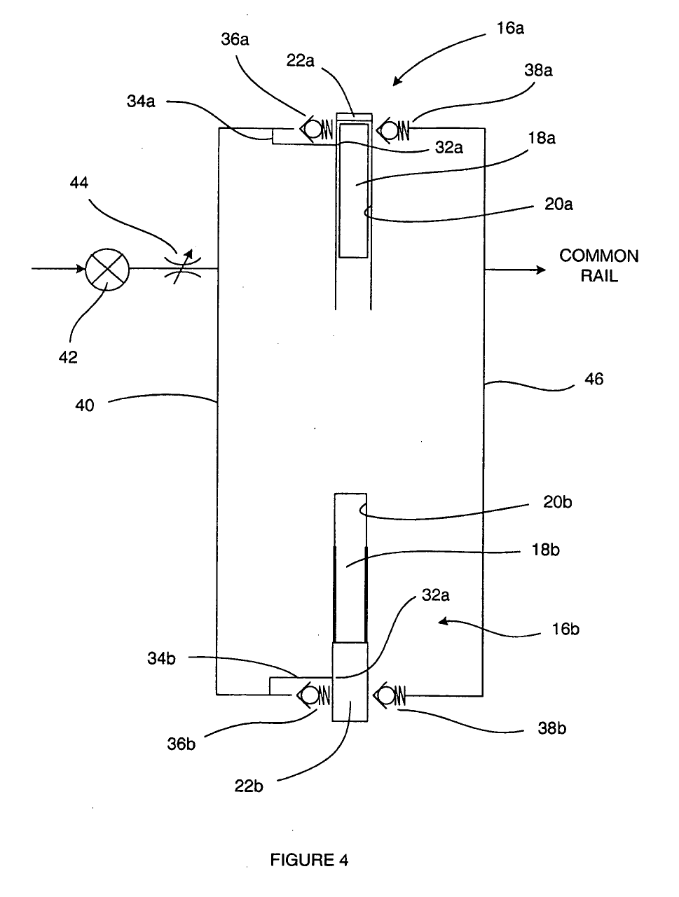

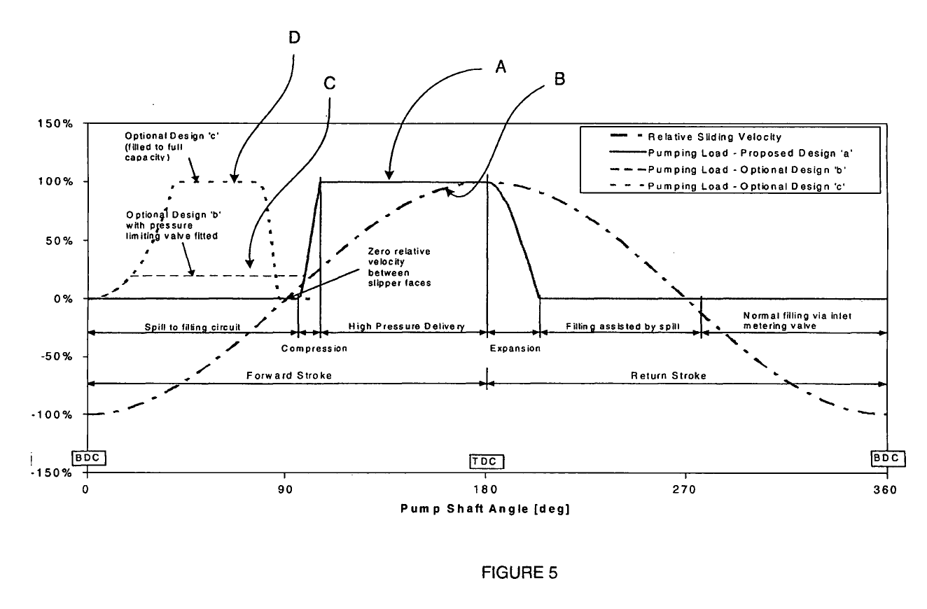

The pump head 16a in FIG. 3 further includes a spill port 32a located part way along the plunger bore 20a which communicates with a supplementary passage 34a provided in the pump head 16a. The port 32a is opened and closed by the plunger 18a as it moves back and forth through the pumping cycle and so provides a load-reducing arrangement for reducing the pumping load during a certain period of the forward stroke, as will now be described with reference to FIGS. 4 and 5.

FIG. 4 shows the hydraulic circuit for the fuel pump in FIG. 3, with the inlet valves 36a, 36b and outlet valves 38a, 38b identified on each of the pump heads 16a, 16b. The port 32a in the plunger bore 20a of the first one of the plungers 18a communicates with the supplementary passage 34a which, in turn, communicates with a common supply passage 40. The common supply passage 40 also communicates with a supplementary passage 34b to a second port 32b provided on the second pump head 16b. Low pressure fuel is delivered by means of a low pressure pump 42 to an inlet metering valve 44 which controls the quantity of fuel supplied to the common supply passage 40.

The fuel pump in FIGS. 3 and 4 operates in a similar manner to the conventional fuel pump of FIG. 1. The plungers 18a, 18b perform a pumping cycle comprising a forward stroke, during which fuel is pressurized within the respective pump chamber 22a, 22b for delivery through the respective outlet valve 38a, 38b, and a return stroke in which the plunger 18a, 18b is moved outwardly from its plunger bore 20a, 20b to permit filling of the pump chamber 22a, 22b ready for the next pumping cycle. Pressurized fuel is supplied through the outlet valve 38a, 38b of each pump head 16a, 16b to a common outlet passage 46 and, from there, to the downstream common rail.

It is a feature of the fuel pump of FIGS. 3 and 4 that pumping only occurs for a certain period of the forward stroke, rather than pumping for the complete forward stroke as in FIG. 1. Starting from BDC, as the first plunger 18a commences its forward stroke, moving towards TDC, the port 32a in the plunger bore 20a is uncovered so that fuel within the pump chamber 22a is displaced through the open port 32a into the supplementary passage 34a, and hence back into the common supply passage 40, for an initial period of the forward stoke. Part way through the forward stroke, at around 90 degrees, the end of the plunger 18a moves past the port 32a in the plunger bore 20a, thereby closing the connection to the supplementary passage 34a. At this point the pumping portion of the forward stroke commences and fuel within the enclosed volume of the pump chamber 22a is pressurized. Once fuel pressure has increased sufficiently to open the outlet valve 38a, high pressure fuel is delivered through the outlet passage 26a into the common outlet passage 46.

The spill port is positioned so as to provide a compromise between unloading the tappet 28a at the critical angle around 90 degrees and maximizing the useful part of the stroke and, hence, increasing pump capacity. In some applications, it may be that delaying closure of the spill port until some significant angle after 90 degrees is advantageous to realize the full benefit of unloading the tappet in the critical period. In other applications, it may be helpful to increase pump capacity at the expense of a slight increase in loading at the minimum point (i.e. that point at which the relative sliding velocity between the tappet 28a and the rider surface 30a is a minimum), in which case the spill port 32a is positioned so as to be covered a few degrees before the minimum point. Although tappet loading at the minimum point is not eliminated entirely in this case, it may nonetheless be reduced sufficiently to provide an advantage.

Once the plunger 18a has reached TDC and commences the return stroke, expansion occurs within the pump chamber 22a causing low pressure fuel to be drawn into the pump chamber 22a through the inlet valve 36a. At the point at which the plunger 18a uncovers the port 32a on the return stroke, filling of the pump chamber 22a also occurs through the open port 32a as fuel is drawn in through the common inlet passage 40 and the supplementary passage 34a. Furthermore, for that period of the forward stroke for which the port 32a is uncovered, fuel within the pump chamber 22a of the first pump head 16a is displaced through the supplementary passage 34a and the common inlet passage 40 to assist filling of the pump chamber 22b of the second pump head 16b through its supplementary passage 34b.

In a similar manner, filling of the pump chamber 22a of the first pump head 16a is assisted by the return flow of fuel during an initial period of the forward stroke of the plunger 18b of the second pump head 16b, through the supplementary passage 34a in the first pump head 16.

In practice, shortly after the port 32a of the first pump head 16a is opened, the inlet valve 36a will close due to the presence of the spring which sets the valve opening pressure. This does not present a problem to fuel delivery control which is still controlled by the inlet metering valve 44. In another embodiment, however, the spring on the inlet valve 36a may be set so that it remains open, even though the port 32a has been uncovered to permit flow into the pump chamber 22a via that route also.

For a partially-filled condition, it is possible that there may be no flow between the pump chambers 22a, 22b during the return stroke of each pump head 16a, 16b, in which case the inlet valve 36a, 36b will not open at all. In this case filling of the pump chamber of one pump head only occurs through the open port, 32a or 32b, once the retracting plunger has reached the point at which the port is uncovered.

FIG. 5 illustrates the pumping load characteristic for the fuel pump in FIGS. 3 and 4. Compared with the characteristics of the conventional fuel pump, it can be seen from FIG. 5 that at that point of the pumping cycle for which the relative sliding velocity between the tappet 28a and the rider surface 30a is a minimum, the pumping load is at its minimum value because pressurization of fuel within the pump chamber 22a has not commenced due to the port 32a being open. This ensures that at the point in the cycle when the thin film effect is non-existent, the pumping load on the tappet 28a is low or substantially non-existent so as to limit wear of the tappet 28a. It is a further benefit that when the pumping load is initially applied to the tappet 28a (i.e. just after 90 degrees), the plunger 18a is more fully engaged within its bore 20a. A more fully engaged plunger may serve to reduce wear of the plunger 18a, and may also reduce leakage losses through the plunger/bore clearance.

While this mode of operation reduces pump capacity as only the latter part of the forward stroke is used for fuel pressurization, this is offset by the benefit that filling of the pump chamber 22b of the other pump head 16b can be assisted by fuel displaced through the open port 32a during the initial part of the forward stroke of the first pump head 16a, and vice versa. Moreover, in order to compensate for the reduction in pump capacity, the stroke of the plunger 18a may be increased by increasing the cam offset (or “throw” of the cam) and providing an increased plunger bore length to accommodate the increased stroke. This provides the added advantage that the relative sliding velocity is increased between the rider surface 30a and the tappet 28a for the same pump speed.

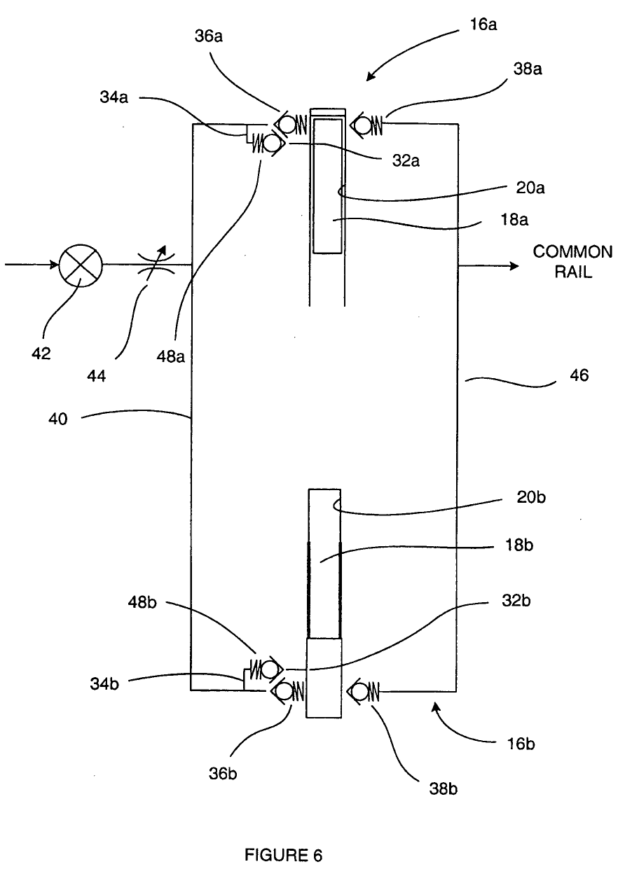

FIG. 6 shows a second embodiment of the fuel pump (design ‘b’) in which like parts to those shown in FIG. 4 are denoted with like reference numerals. The fuel pump is similar to the first embodiment in that the plunger bore 20a, 20b of each pump head 16a, 16b is provided with a port 32a, 32b, but in addition each port 32a, 32b is provided with a valve arrangement in the form of a pressure limiting valve, 48a, 48b respectively.

Referring also to FIG. 5, line C indicates that, for the initial part of the forward stroke, between about 30 degrees and 90 degrees, the pump chamber 22a of the first pump head 16a is primed to an intermediate pressure, as determined by the pressure limiting valve 48a. For this initial part of the forward stroke, when fuel pressure in the pump chamber 22a reaches the intermediate pressure the pressure limiting valve 48a is caused to open to maintain pressure in the pump chamber 22a at this intermediate pressure. However, full pressurization does not take place until at least 90 degrees after BDC when the plunger 18a has moved so far through its forward stroke that the port 32a is covered by the plunger 18a, closing off the pressure limiting valve 48a.

In this embodiment filling of the second pump chamber 22b is again assisted by fuel being displaced through the port 32a of the first pump head 16b and its open pressure limiting valve 48a for the initial part of the forward stroke of the first plunger 18a.

It will be appreciated that in the embodiment shown in FIG. 6, the pump chamber being filled is not filled via its port 32a, 32b due to the presence of the pressure limiting valves 48a, 48b, and hence fills only through its inlet valve, 36a or 36b.

As described for the first embodiment, for that period of the forward stroke for which the relative velocity between the tappet 28a and the rider surface 30a is a minimum (at around 90 degrees) when there is no hydrodynamic lubrication, the pumping load on the tappet 28a is at a relatively low pressure level (i.e. the intermediate pressure level) compared with a conventional pump so that wear on the tappet 28a is reduced at a time when it is usually most vulnerable.

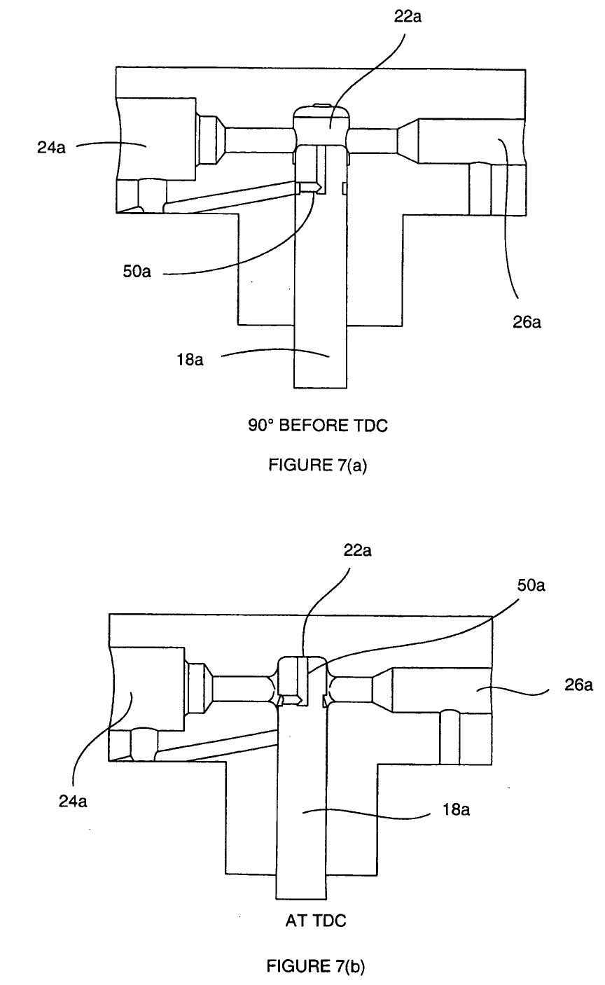

A third embodiment of the invention is shown in FIGS. 7(a) and 7(b). In this embodiment, again the port 32a is provided on the pump head 16a, but without the pressure limiting valve 48a of FIG. 6. Instead, the plunger 18a is provided with a drilling 50a which defines a communication path between the pump chamber 22a and the port 32a for certain positions of the plunger 18a. The drilling 50a includes an axial portion, the open end of which communicates with the pump chamber 22a, and a radial portion, the open end of which communicates with the port 32a.

Initially, when the plunger 18a is at BDC, the port 32a is covered so that, for the initial part of the forward stroke, the pressure of fuel within the pump chamber 22a is increased as the plunger 18a moves towards TDC. When the plunger 18a reaches 90 degrees before TDC (the position shown in FIG. 7(a)), the open end of the drilling 50a in the plunger 18a is brought into communication with the port 32a, thereby allowing fuel within the pump chamber 22a to flow through the drilling 50a and out through the port 32a into the pump chamber of the other pump head (not shown) via the common inlet passage 40. Spilling of fuel from the pump chamber 22a through the port 32a continues for a short period (between about 80 degrees and 90 degrees) until the port 32a is closed by the plunger 18a moving further towards TDC to allow pressurization of fuel to commence again. The provision of the drilling 50a in the plunger 18a means that only the initial and latter parts of the forward stroke are used for pumping, whereas the intermediate portion is used for spilling fuel through the port 32a to the other pump head.

FIG. 5 shows the pumping load as a function of engine position for this third embodiment of the invention, where it can be seen from line D that, for the period around 90 degrees where the relative sliding velocity between the tappet 28a and the rider flat 30a is a minimum, the pumping load falls to zero. As pumping load is substantially non-existent for the period when the relative sliding velocity is a minimum, the non-existence of thin film lubrication during this period does not lead to increased wear of the tappet, as in a conventional pump.

It will be appreciated that the invention is applicable to any single or multi-plunger pump, and is not limited to a two plunger pump as shown in the accompanying drawings.

1. A fuel pump for delivering fuel at rail pressure to a common rail of a fuel injection system, the fuel pump comprising:
a pumping plunger reciprocal within a plunger bore under the influence of a drive member so as to pressurize fuel within a pump chamber, the drive member being co-operable with a cam rider so as to impart axial drive to the plunger to reduce the volume of the pump chamber, in use, while permitting lateral sliding movement of the cam rider relative to the drive member;
wherein the pumping plunger is configured and arranged to perform a pumping cycle including: (i) a forward stroke, during which the pumping plunger moves between bottom-dead-centre and top-dead-centre, and fuel within the pump chamber is pressurized to a relatively high pressure level; and (ii) a return stroke, during which the pumping plunger moves between top-dead-centre and bottom-dead-centre to allow the pump chamber to fill with fuel at a relatively low pressure level;
the pump further comprising a load-reducing arrangement for reducing the load on the drive member due to fuel pressure within the pump chamber during that period of the forward stroke for which the relative velocity of sliding movement between the drive member and the cam rider is approximately a minimum.

2. The fuel pump as claimed in claim 1, wherein the load-reducing arrangement includes a spill port provided in the plunger bore.

3. The fuel pump as claimed in claim 2, wherein the spill port is positioned so as to be covered by the pumping plunger part way through the forward stroke so as to delay the onset of fuel pressurization to rail pressure until at least that point in the forward stroke at which the relative velocity of sliding movement between the drive member and the cam rider is approximately a minimum.

4. The fuel pump as claimed in claim 3, further comprising a valve arrangement operable to limit pressurization of fuel within the pump chamber to an intermediate level, less than rail pressure, during that period of the forward stroke for which the relative velocity of sliding movement between the drive member and the cam rider is approximately a minimum.

5. The fuel pump as claimed in claim 3, wherein the spill port is positioned in the plunger bore so as to be covered by the pumping plunger when the pumping plunger is at least 90 degrees after bottom-dead-centre.

6. The fuel pump as claimed in claim 5, wherein the spill port is positioned in the plunger bore so as to be covered by the pumping plunger when the pumping plunger is at least 110 degrees after bottom-dead-centre.

7. The fuel pump as claimed in claim 2, wherein the spill port is positioned so as to be covered by the pumping plunger part way through the forward stroke so as to delay the onset of fuel pressurization until just before that point in the forward stroke at which the relative velocity of sliding movement between the drive member and the cam rider is a minimum.

8. The fuel pump as claimed in claim 7, wherein the spill port is positioned in the plunger bore so as to be covered by the pumping plunger when the pumping plunger is around 85 degrees after bottom-dead-centre.

9. The fuel pump as claimed in claim 2, wherein the pumping plunger is provided with a feature which aligns with the spill port to permit fuel to flow out of the pump chamber through the spill port during an intermediate portion of the forward stroke including a period for which the relative velocity of sliding movement between the drive member and the cam rider is a minimum.

10. The fuel pump as claimed in claim 9, wherein the intermediate portion of the forward stroke is between approximately 70 degrees and 110 degrees after bottom-dead-centre.

11. The fuel pump as claimed in claim 10, wherein the intermediate portion of the forward stroke is between approximately 80 degrees and 100 degrees after bottom-dead-centre.

12. The fuel pump as claimed in claim 11, wherein the intermediate portion of the forward stroke includes approximately 90 degrees after bottom-dead-centre.

13. The fuel pump as claimed in claim 2, further comprising one or more further pump chambers;
said further pump chambers having a further pumping plunger for performing a pumping cycle including: (i) a forward stroke, during which the further pumping plunger moves between bottom-dead-centre and top-dead-centre, and fuel within the further pump chamber is pressurized to a relatively high level; and (ii) a return stroke, during which the further pumping plunger moves between top-dead-centre and bottom-dead-centre to allow the further pump chamber to fill with fuel at relatively low pressure;
each of the further pumping plungers having an associated drive member that is co-operable with the cam rider so as to impart axial drive to the further pumping plunger to reduce the volume of the further pump chamber, in use, while permitting lateral sliding movement of the cam rider relative to the associated drive member;
each further pumping plunger being provided with an associated load-reducing arrangement for reducing the load on its associated drive member due to fuel pressure within its pump chamber during that period of its forward stroke, for which the relative velocity of sliding movement between its associated drive member and the cam rider is at a minimum.

14. The fuel pump as claimed in claim 13, wherein the one or more further pump chambers is provided with a respective spill port which communicates with one of the other pump chambers of the pump to aid filling thereof during an associated return stroke.

15. A fuel pump for delivering fuel at rail pressure to a common rail of a fuel injection system, the fuel pump comprising:
a pumping plunger reciprocal within a plunger bore under the influence of a drive member so as to pressurize fuel within a pump chamber, the drive member being co-operable with a cam rider so as to impart axial drive to the plunger while permitting lateral sliding movement of the cam rider relative to the drive member, wherein the pumping plunger is configured and arranged to perform a pumping cycle including a forward stroke during which the pumping plunger moves between bottom-dead-centre and top-dead-centre and a return stroke during which the pumping plunger moves between top-dead-centre and bottom-dead-centre;
the pump further comprising a spill port provided in the plunger bore and the pumping plunger being provided with a feature that aligns with the spill port to permit fuel to flow out of the pump chamber through the spill port during an intermediate portion of the forward stroke including a period, for which the relative velocity of sliding movement between the drive member and the cam rider is a minimum.

16. The fuel pump as claimed in claim 15, wherein the intermediate portion of the forward stroke is between approximately 70 degrees and 110 degrees after bottom-dead-centre.

17. The fuel pump as claimed in claim 16, wherein the intermediate portion of the forward stroke includes approximately 90 degrees after bottom-dead-centre.

18. A fuel pump for delivering fuel at rail pressure to a common rail of a fuel injection system, the fuel pump comprising:
a pumping plunger reciprocal within a plunger bore under the influence of a drive member so as to pressurize fuel within a pump chamber, the drive member being co-operable with a cam rider so as to impart axial drive to the plunger while permitting lateral sliding movement of the cam rider relative to the drive member,
wherein the pumping plunger is configured and arranged to perform a pumping cycle including: (i) a forward stroke, during which the pumping plunger moves between bottom-dead-centre and top-dead-centre; and (ii) a return stroke, during which the pumping plunger moves between top-dead-centre and bottom-dead-centre;
the pump further comprising a spill port provided in the plunger bore at a position so as to be covered by the pumping plunger part way through the forward stroke and so as to delay the onset of fuel pressurization to rail pressure until approximately that point in the forward stroke, at which the relative velocity of sliding movement between the drive member and the cam rider is approximately a minimum.

19. The fuel pump as claimed in claim 18, wherein the spill port is positioned in the plunger bore so as to be covered by the pumping plunger when the pumping plunger is around 85 degrees after bottom-dead-centre.
